(19) United States
(12) Patent Application Publication
(10) Pub. No.: US 2012/0037252 A1
(43) Pub. Date: Feb. 16, 2012

(54) Material Transfer System

(76) Inventor: Scott A. Stephan, Ham Lake, MN (US)

(21) Appl. No.: 13/209,503

(22) Filed: Aug. 15, 2011

Related U.S. Application Data
(60) Provisional application No. 61/374,032, filed on Aug. 16, 2010.

(51) Int. Cl. F16L 37/00

(52) U.S. Cl. 137/798

(57) ABSTRACT

A material transfer device for coupling the threaded pour spout of two containers to one another to permit transfer of liquid product from one container to the other. The basic coupling device comprises a tubular member having at least two different thread patterns at opposed ends, allowing the coupler to be used with containers of multiple differing thread patterns, i.e., diameter and/or thread pitch. The coupler also includes internal sealing flanges to prevent seepage of product from the joined containers.

### CROSS-REFERENCE TO RELATED APPLICATION

This application is a continuation-in-part of provisional application Ser. No. 61/374,032, filed Aug. 16, 2010, the contents of which are hereby incorporated by reference.

### FIELD OF THE INVENTION

This invention relates generally to material transfer apparatus, and more particularly to connector or coupler devices for joining the necks of two bottles or other similar containers having a threaded neck or pour spout to one another so that the contents of one can be transferred into the other.

### DISCUSSION OF THE PRIOR ART

To avoid waste while saving money and to avoid contamination of landfills, it is often desirable to more completely empty a container before disposing of it in the trash. For example, for viscous fluids like motor oil, lotions, shampoos, ketchup, etc., it may require several minutes for all of the contents of the bottle or container to empty when inverted. Hence, there is a tendency for persons to simply discard the container with a quantity of the product remaining in it rather than waiting the time required to more fully empty it.

The prior art discloses couplers that can be threaded onto the necks of two containers so that the one to be emptied is inverted over the open mouth of a second container, allowing gravity to transfer the contents of the container to be emptied into the second container without the need for supervision. The Indrunas U.S. Pat. No. 3,615,150 is one example. In the lndrunas '150 patent, a bottle coupling element 12 comprises a tube having first and second ends that are internally threaded with a diameter and pitch allowing it to be screwed onto the external threads on the necks of two identical containers. The containers are then placed in a rack and held in an upright condition so that the contents of the uppermost container will drain through the coupling element into the lower container, the lower container having an empty volume sufficient to accommodate what is remaining in the upper container.

The Shimei et al. U.S. Pat. No. 6,910,720 teaches a similar connector, but without the use of a threaded connection between the two containers and the transfer tube. Instead, an interference fit between the transfer tube and the two containers is relied upon.

The container transfer devices of the prior art lack versatility. When it is considered that bottles are often of differing sizes, especially in respect to their neck diameters and thread pitch, the prior art couplers cannot be used unless specifically designed to fit the particular bottle neck size on a one-to-one basis. Thus, for example, if it is desired to transfer, say ketchup, from a standard size bottle into a larger capacity “family size” bottle, the conventional coupler of the prior art will not fit both bottles since the diameter and pitch of the two containers may differ from what the coupler has been designed for.

Thus, a need exists fora material transfer device of greater versatility, capable of accommodating not only two identical containers, but also multiple containers with differing neck finishes, i.e., different diameter of threads and different pitch angles.

When dealing with thick, viscous fluids, spilling or leakage is generally not a problem when joining the necks of the two containers to a material transfer coupler. However, with less viscous fluids, like water for example, it is difficult to secure the bottle necks together without spilling because for threaded attachment to occur, one bottle has to have its open top inverted as the connection is being made, thus causing a spill of its contents.

It is therefore another object of the invention to obviate this spillage/leakage problem when dealing with low viscosity fluids.

Another problem present in prior art coupler designs of which I am aware is that they do not provide adequate sealing such that leakage occurs between the internally threaded surface of the couple and the external neck threads of the container with which it is being use. It is therefore still another object of the invention to obviate this leakage problem through the design of the dual stage thread stops.

### SUMMARY OF THE INVENTION

The present invention provides a coupler for joining the externally threaded necks of first and second fluid containers for transferring fluid contents from the first container into the second container without leakage. The coupler comprises a tubular body with first and second open ends of predetermined diameters and internal threads progressing inwardly from the first and second ends, starting with a first thread pattern (diameter and pitch) extending from the first end and the same or a different thread pattern extending from the second end for a first predetermined length of the tubular body and continuing with a second thread pattern of a lesser predetermined diameter for a second predetermined length. An annular seal stop is disposed between an end point of the first thread pattern and a start of the second thread pattern, the annular seal stop adapted to engage a peripheral surface of the externally threaded neck surrounding its open end of said first and second fluid containers when screwed into the open ends of the tubular body.

In accordance with a further feature of the invention, a further annular seal stop flange is disposed at the end of the second thread pattern and is adapted to engage a peripheral surface of the externally threaded neck surrounding its open top of a container screwed into the second thread pattern.

To obviate spilling and leakage when joining containers with low viscosity liquids in them, the coupler may also include a one-way flow valve placed between the further annular seal stops at the end of the second thread patterns.

### DESCRIPTION OF THE DRAWINGS

The foregoing features, objects and advantages of the invention will become apparent to those skilled in the art from the following detailed description of preferred embodiments, especially when considered in conjunction with the accompanying drawings in which like numerals in the several views refer to corresponding parts.

FIG. 1 is a perspective drawing showing two containers having externally threaded necks coupled to one another by the device of the present invention;

FIG. 2 is a perspective view of a coupler in accordance with the present invention;

FIG. 3 is a cross-sectional view of the coupler of FIG. 2 revealing multiple thread patterns spaced longitudinally from one another;

FIG. 4 is a cross-sectional view of a further embodiment incorporating a one-way ball flow control valve;

FIG. 5 is a cross-sectional view of a further embodiment of a coupler incorporating a one-way diaphragm valve;

FIG. 6 is a greatly enlarged, longitudinal, cross-sectioned view of a coupler having optional coupler rings cooperating therewith to expand the number of different container neck thread patterns that can be coupled together; and

FIG. 7 is a longitudinal cross-sectioned view similar to the device illustrated in FIGS. 3 and 6.

### DESCRIPTION OF THE PREFERRED EMBODIMENT

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise.

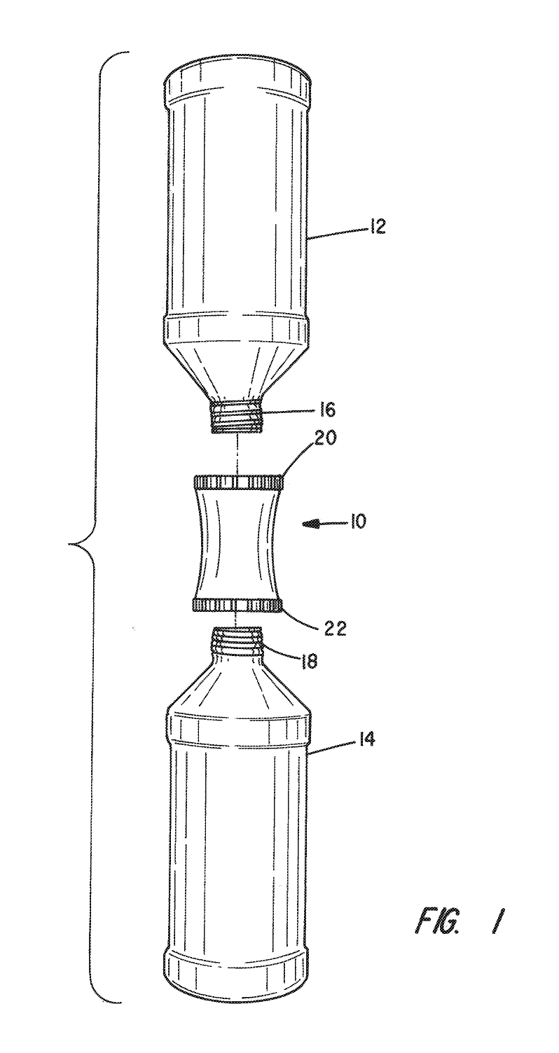

In FIG. 1, there is shown a basic coupler indicated generally by numeral 10 for joining two containers, here shown as plastic bottles 12 and 14 together by a threaded connection between necks 16 and 18 with internal threads (not shown) within the tubular coupler 10. Thus, when the two bottles are joined together in the manner described, the remaining contents present in the upper bottle 12 can flow into and be saved in the lower bottle 14.

As will be explained in greater detail below, the bottles 12 and 14 may have either the same or a different thread pattern on their necks 16 and 18. By thread pattern is meant either or both the diameter or thread pitch. As such, the two bottles employed need not be identical.

The coupler 10 is preferably formed of a suitable elastomer in a molding operation with internal threads of multiple predetermined thread patterns. The outer periphery at upper and lower ends of the coupler 20 and 22 may be knurled to facilitate gripping as the bottle necks 16 and 18 are screwed into the coupler.

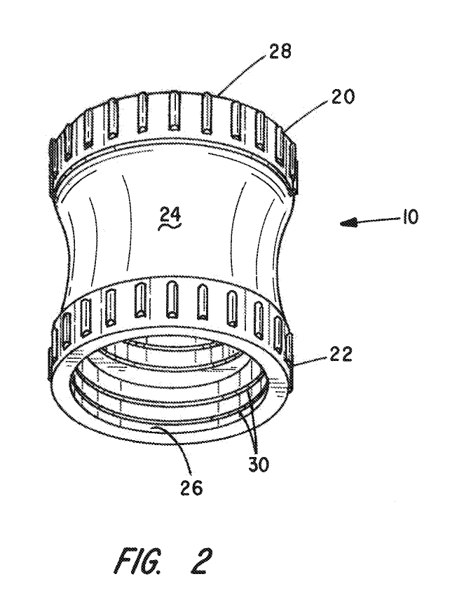

Referring next to FIG. 2, it shows an enlarged perspective view of a preferred embodiment of the coupler 10. It can be seen that it comprises a tubular body 24 with first and second open ends 26, 28 of predetermined diameters and internal threads, as at 30, progressing inwardly from the first and second open ends beginning with a first thread pattern extending from the first and second open ends for a predetermined length of the tubular body and from there continuing with a second thread pattern of a lesser predetermined diameter and with the same or a different pitch for a second predetermined length. As shown in FIG. 2, the external body 24 may be smooth, textured, knurled or embossed with symbols or letters for gripping or identification.

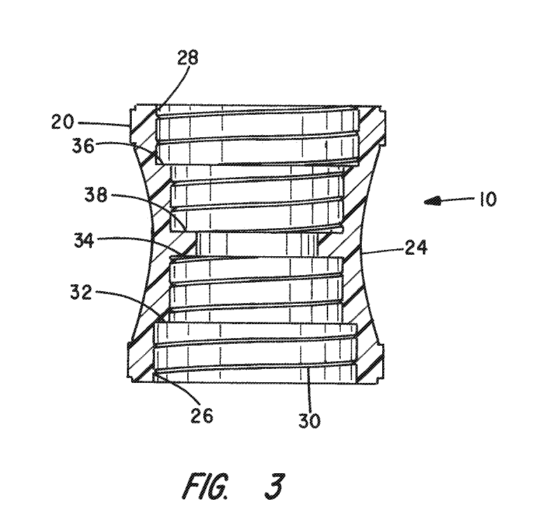

More particularly, and with reference to the cross-sectional view of FIG. 3, the first thread pattern 30 extends inwardly from open end 26 ending at a shoulder forming a seal stop 32 and from there the thread pattern changes to a second one ending at a shoulder forming a seal stop 34. From this view, it can be appreciated that bottles conforming to the first thread pattern can be threaded into the open end 26 until the peripheral surface of the bottle's open neck abuts the seal stop 32. The coupler can also accommodate a bottle having a thread pattern on its neck of a lesser diameter and possibly of a different thread pitch by inserting it through the zone having the first thread pattern 30 to thereby engage the threads in the zone terminating at the seal stop 34.

The seal stops 32 and 34 comprise an annular sealing flange disposed between an endpoint of the first thread pattern and the start of the second thread pattern and also at the terminus of the second thread pattern. These annular seal stops are adapted to engage a circumferential top surface on the threaded neck of the containers defining its opening when screwed into the open ends of the tubular body. The presence of these annular seal stops precludes leakage of the fluid contents in the bottle between coacting threads of the coupler and the bottleneck.

With continued reference to FIG. 3, the upper open end 28 of the coupler 10 is of a internal diameter that may be either the same as or different from the internal diameter of the open lower end 26 and threads progress inwardly therefrom ending at a seal stop 36 where the thread pattern transitions to a lesser diameter and possibly a differing pitch and terminating at the seal stop 38.

It should be apparent to those skilled in the art from what has heretofore been described that the coupler of the present invention can be used to mate the open necks of bottles or other containers that need not be identical, thus making the coupler of the present invention substantially more versatile than prior art couplers designed for the same overall purpose of mating two bottles so as to empty the contents of one into the other.

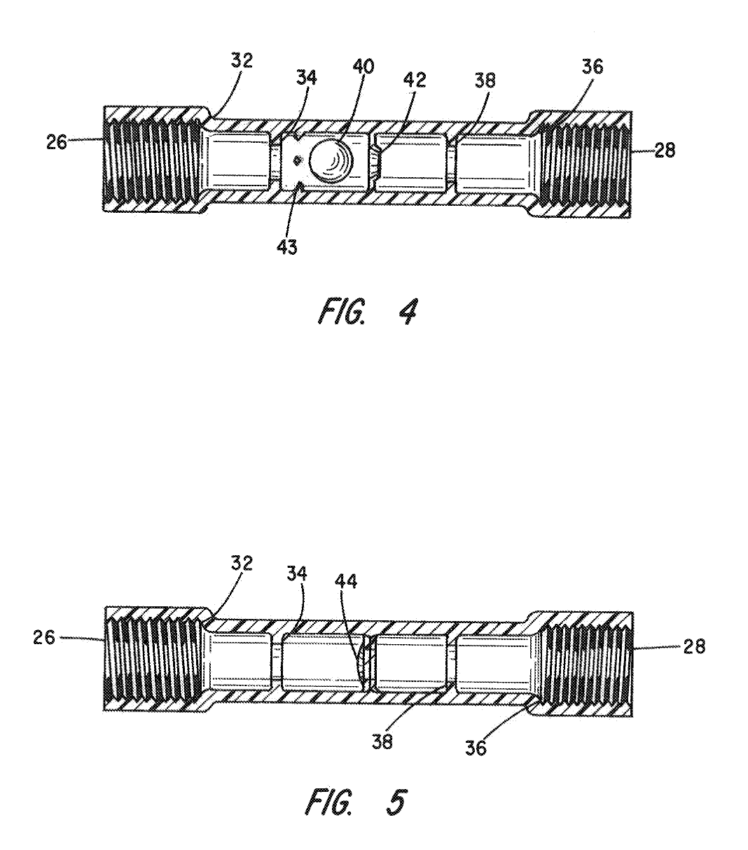

Referring once more to FIG. 1, it can be appreciated that in dealing with more viscous fluids such as liquid soaps, lotions, shampoos and food items like ketchup and syrup that it is possible to readily mate the two bottles together using the coupler 10 without spilling in that the contents of the upper bottle 12 do not immediately begin to flow out the open neck 16 upon inverting the bottle 12. Thus, the coupler 10 may first be screwed onto the neck 18 of the lower bottle 14 and then the upper bottle 12 inverted and screwed into the open end 20 of the coupler 10 without experiencing spillage. However, when dealing with liquids of a lesser viscosity, say those having the viscosity of motor oil, there is a strong likelihood that spillage will occur as an attempt is made to invert the upper bottle 12 and screw it into the open upper end 20 of the coupler 10. To obviate this problem, in accordance with a further embodiment more particularly illustrated in FIG. 4, there is provided a one-way valve, here shown as a ball valve, into the body of the coupler. More particularly, a ball member 40 cooperates with a valve seat 42 to block liquid flow when the ball is seated in the valve seat 42, but permits flow when coming from a direction that dislodges the ball 40 from its seat 42. The ball is of a diameter allowing insertion through open end 26 and a series of circumferentially spaced resilient protrusions or barbs 43 deflect under insertion forces to allow the ball to pass but these self-expand to prevent the ball from falling back out of the coupler.

In use, the open end 26 may be screwed onto the neck of the bottle to be filled and with the coupler so attached, the bottle to be filled in inverted causing the ball 40 to move against the seat 42 and block fluid flow from the bottle to be filled. Next, the bottle to be emptied is screwed into the open end 28 of the coupler and once that is done, the entire assembly is inverted such that the bottle to be emptied is superior to the one to be filled and the inversion results in the ball 40 unseating to permit the flow of liquid through the opening in the valve seat 42 permitting the contents of the bottle to be emptied to flow into the bottle to be filled. Again, the barbs 43 prevent the ball 40 from falling out of the coupler.

FIG. 5 is similar to the embodiment of FIG. 4 but instead of utilizing a ball valve, it employs a one-way diaphragm valve. A diaphragm valve or membrane valve consists of a valve body with two or more ports, a diaphragm and a “saddle” or “seat” upon which the diaphragm closes the valve. A typical diaphragm valve comprises a valve body supporting a disk that moves in a plane that is at right angles to the direction of flow of fluid and is resisted by a spring that is held in place by a retainer or flexible membrane material found in common disc valves. When the force exerted on the disk by the upstream pressure is greater than the force exerted by the spring, the disk is forced to lift off its seat allowing flow through the valve. When the differential pressure across the valve is reduced, the spring forces the disk back into its seat closing the valve just before reverse flow occurs. No spring is needed where the differential pressure across the valve is low.

In FIG. 5, the one-way diaphragm-type check valve is identified by the numeral 44. The operation of the coupler of FIG. 5 is very similar to what was explained in connection with the ball valve embodiment of FIG. 4. With the bottle to be filled upright, the coupler has its end 26 placed over the neck and depending upon the thread pattern of the bottle it will be engaged either by the threads leading to the stop 32 or the threads leading to the stop 34. Now, when the bottle to be filled with the coupler attached is inverted, the valve is closed and the bottle to be emptied is screwed onto the appropriate threads accessible through the open end 28. Then, when the entire assembly of the two bottles and coupler are again inverted, the diaphragm valve 44 opens, allowing the fluid from the bottle to be emptied to pass into the bottle to be filled. The reader should understand that the couplers of FIGS. 4 and 5 may have the thread and seal stop arrangements described in the discussion of FIGS. 1-3.

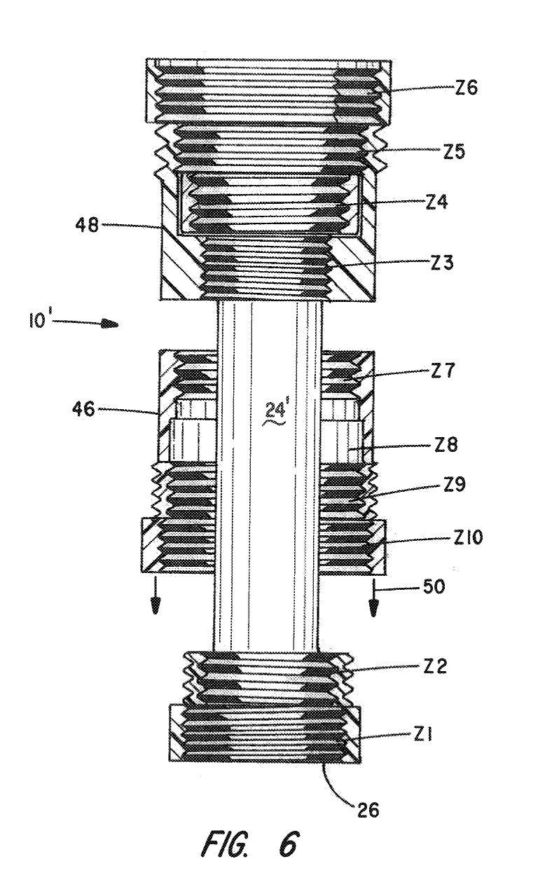

Referring next to FIG. 6, a further embodiment is shown in which the number of different container neck patterns can be extended beyond the four permitted by the embodiment of FIG. 1. FIG. 6 is a greatly enlarged, longitudinally cross-sectioned view showing the coupler 10 having first and second coupler rings 46 and 48 mounted thereon. The coupler ring 46 is shown loosely surrounding the body portion 24′ of the coupler so as to be slidable therealong. Integrally attached threaded end portions or zones Z1 and Z2 on the lower end and zone Z3 and Z4 integrally attached at the upper end are seen in FIG. 6. The coupler ring 48 is shown as having been threaded onto the zones Z3 and Z4 to thereby allow containers of four different thread patterns (diameters and/or thread pitches) to be secured to the coupler 10′. These two additional zones added into zones Z3 and Z4 are labeled Z5 and Z6 in FIG. 6.

When the ring coupler 46 is allowed to slide down the central portion of the coupler 24′ as indicated by the arrows 50, the threads of zones Z2 will mesh with the threads of zone Z7 while the threaded portion labeled Z1 will fit into the threadless zone Z8 of the coupler 46. This will add two additional thread patterns, i.e., those of Z9 and Z10.

It is also to be noted that zones 5 and 9 include external threads thereon whereby an additional ring (not shown) can be screwed onto each of the coupler rings 46 and 48 to expand the number of accessible thread patterns even further so as to accommodate containers whose thread patterns vary in steps from large to small.

Those skilled in the art can appreciate that there are alternative ways of increasing the number of thread patterns, other than providing coupler rings of the type illustrated in FIG. 6. For example, by providing external threads on the members at zones Z1 and Z6, they could be made to mate with internal threads on a stepped ring extender (not shown).

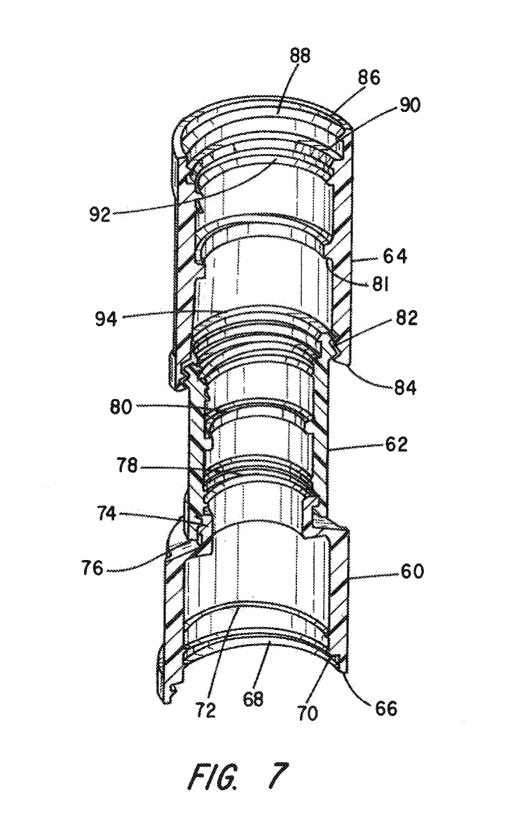

Referring next to FIG. 7, it shows a longitudinal cross-section view of a further preferred embodiment of my material transfer system that is specifically designed to accommodate a pair of containers where each may have any one of a variety of pour spout thread finishes used on bottles and jugs.

The device of FIG. 7 comprises a three-piece assembly of a bottom member 60, an intermediate member 62 and an upper tubular extender member 64. The three members are again preferably molded from a suitable food grade plastic, although any suitable material may be used in part or in its entirety based upon production feasibility, cost and availability now or in the future. Member 62 closely resembles the device of FIG. 2 except that the knurled ends 20, 22 are replaced by external threads.

The bottom member 60 is cylindrical with an open lower end 66 and is internally threaded at 68 to accept a bottle neck with external threads of a first finish and ending at an annular seal stop 70. Extending inward from the seal stop 70 are internal threads 72 of a second finish exhibiting a lesser diameter than that of the threads 68. Member 60 shows a single annular thread stop at 70. A second finish of lesser diameter 72 uses its threads and those of a bottle to create a leak-proof seal.

Formed at the upper end portion of the bottom member 60 is an externally threaded upright collar 74 designed to mate with internal threads that extend inward from a lower end 76 of the intermediate member 62. The intermediate member 62 is also internally threaded, as at 78, to accept the threaded neck of a container (not shown) when the bottom member 60 is disconnected and not being used. Seal stops 80 and 81 are also integrally molded in the tubular body of the intermediate member 62, and the extender member 64, respectively.

The upper end portion of the intermediate member 62 has external threads 82 formed thereon for mating with internal threads located proximate the lower end 84 of the upper tubular extender member 64. Although not seen in member 62, it is further contemplated that optional external threads may be formed about the bottom end of the intermediate member to allow a different lower member, like 60, but having internal threads like 82 on member 64, to be screwed onto the member 62. Thus, the three members 60, 62 and 64 are adapted to screw together or to be used with one or the other of the bottom member 60 or the upper extender member 64 disconnected from the intermediate member.

The upper tubular extender member 64 is seen to include an open top 86 that is internally threaded in a zone at 88 to accept an externally threaded bottle neck (not shown) of a predetermined diameter. A seal stop 90 separates the threaded zone 88 from an adjacent threaded zone 92 designed to accept the neck of a bottle (not shown) that is externally threaded and of a lesser diameter than the threaded zone 88.

In that the upper extender member 64 can be detached from the intermediate member 62, the intermediate member may also be internally threaded at its upper end 94 to accommodate a bottle neck of either the same or different thread finish than can be threads that are formed proximate the lower end of the intermediate member 62.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A coupler for joining the externally threaded necks of first and second fluid containers for transferring fluid contents from the first container into the second container without leakage comprising:
(a) a tubular body with first and second open ends of predetermined diameters and internal threads progressing inwardly from the first and second ends, starting with a first thread pattern extending from the first and second ends for a first predetermined length of the tubular body and continuing with a second thread pattern of a lesser predetermined diameter fora second predetermined length; and
(b) an annular seal stop disposed between an end point of the first thread pattern and a start of the second thread pattern, the annular seal stop adapted to engage a peripheral surface of the threaded neck of said first and second fluid containers when screwed into the open ends of the tubular body.

2. The coupler of claim 1 and further including a further annular seal stop disposed at the end of the second thread pattern adapted to engage a peripheral surface of the threaded neck of a container screwed into the second thread pattern.

3. The coupler of claim 2 and further including a one-way flow valve disposed in the tubular body between the further annular seal stop at the end of the second thread pattern.

4. The coupler of claim 3 wherein the one-way flow valve comprises a ball valve.

5. The coupler of claim 3 wherein the one-way flow valve comprises a diaphragm valve.

6. The coupler of claim 1 wherein the tubular body includes external threads formed thereon proximate at least one of the first and second open ends.

7. A coupler for joining the externally threaded neck of first and second containers together for transferring fluid contents from the first container into the second container comprising:
(a) a tubular body with first and second ends with internal threads of a first diameter extending inward from said first end for a first longitudinal distance and ending at a first annular seal stop;
(b) the tubular body having internal threads of a predetermined diameter the same as or different from said first diameter extending inward from the second end for a second longitudinal distance and ending at a second annular seal stop; and
(c) whereby said coupler can be threaded on to the externally threaded neck of the first container until an open end of the externally threaded neck of the first container abuts the first annular seal stop and onto the externally threaded neck of the second container until an open end of the externally threaded neck of the second container abuts the second annular seal stop.

8. The coupler as in claim 7 and further including internal threads of a lesser diameter than said first diameter extending longitudinally for a predetermined distance from the first annular seal stop and ending at a third annular seal stop.

9. The coupler as in claim 7 and further including internal threads of a lesser diameter than said predetermined diameter extending longitudinally for a predetermined distance from the second annular seal stop and ending at a further annular seal stop.

10. The coupler as in claim 8 and further including internal threads of a lesser diameter than said predetermined diameter extending longitudinally fora predetermined distance from the second annular seal stop and ending at a further annular seal stop.

11. The coupler of claim 10 and further including a one-way flow valve disposed between the third and the further annular seal stops.

12. The coupler of claim 11 wherein the one-way valve is a ball valve.

13. The coupler as in claim 11 wherein the one-way valve is a diaphragm valve.

14. The coupler of claim 7 wherein the tubular body comprises a polymeric material.

15. A coupler as in claim 1 and further including:
a coupler ring surrounding said tubular body, the coupler ring being slidable on the tubular body and including an open end of a predetermined internal diameter greater than the predetermined diameter of the first open end of the tubular body.

16. The coupler as in claim 15 wherein the coupler ring includes a thread pattern adapted to receive and mate with external threads on a neck of one of the first and second containers.

17. The coupler as in claim 16 wherein the coupler ring includes a zone with internal threads for receiving and mating with external threads on the tubular body, the zone located such that the open end of the coupler ring extends longitudinally beyond one of the first and second open ends of the tubular body when the external threads on the tubular body are mated with the internal threads on said zone of the coupler ring.

18. The coupler as in claim 6 and further including a cylindrical tubular extender threaded onto said external threads of the tubular body.
